(19) United States
(12) Patent Application Publication
(10) Pub. No.: US 2011/0219084 A1
(43) Pub. Date: Sep. 8, 2011

(54) PARENTAL CONTROL FOR MULTIPLE VIRTUAL ENVIRONMENTS OF A USER

(75) Inventors: Pier Borra, Summit, NJ (US); Alexander D. Westerman, Los Angeles, CA (US)

(73) Assignee: MTV Networks, a division of Viacom International, Inc., New York, NY (US)

(21) Appl. No.: 13/042,216

(22) Filed: Mar. 7, 2011

Related U.S. Application Data
(63) Continuation-in-part of application No. 11/840,647, filed on Aug. 17, 2007.

(51) Int. Cl. G06F 15/16; H04L 9/32

(52) U.S. Cl. 709/206; 726/4

(57) ABSTRACT

A computerized method is for controlling a virtual environment of a user and includes providing, over a communications network, a plurality of virtual environments in which a user is able to interact with other users using electronic messaging. The computerized method also includes transmitting, from an authentication server, information about the plurality of virtual environments to a first computing device associated with an agent in response to user request for access to a restricted electronic messaging format associated with one of the virtual worlds. The computerized method further includes receiving, at the authentication server, an indication of authorization from the first computing device, wherein the indication of authorization includes a separate indication of authorization associated with each of the plurality of virtual environments.

### RELATED APPLICATIONS

The present application is a continuation-in-part of U.S. application Ser. No. 11/840,647, filed Aug. 17, 2007 and titled “System and Method for Controlling a Virtual Environment of a User,” the contents of which are expressly incorporated by reference herein.

### FIELD OF THE INVENTION

The present invention generally relates to methods of controlling a virtual environment of a user of a network, such as the Internet, by which multiple users interact. The present invention also relates to corresponding systems and computer-readable media.

### BACKGROUND OF THE INVENTION

As the Internet has become an increasingly popular, if not universal, medium of communication, its use among children has likewise grown. Due to the generally unfettered nature of the medium, in that the Internet is publicly accessible and in that a user can access any websites, concerns have arisen as to how to protect children on line. It is desired to protect children from language or other material that is inappropriate or unsuitable, such as that containing obscenity, violence, threats, sexual content, offensive content, etc. It is also desired to protect children from interactions with sexual predators, criminals and others who may engage in illegal or immoral behavior. It is well documented that such interactions may be initiated by contacting children on the Internet. One way of preventing such interactions and their initiation on line is by preventing children and others from communicating personally identifiable information, such as names and addresses, on line. Finally, it is acknowledged that parents have an interest and a role in protecting their children on the Internet, and also that different parents seek different degrees or levels of protection for their children.

In view of the issue of child protection on the Internet, it would be useful to control children's environment on the Internet so as to eliminate language or other content that is inappropriate or unsuitable for children, and to prevent the transmission of personally identifiable information. It would also be useful to let parents exercise such control and to do so in such a manner as to permit parents of different children to implement different degrees or levels of protection.

Attempts to solve some of these problems have involved monitoring of online communication, together with imposing sanctions on violators of child protection policies and alerting parents of such violations. Monitoring, whether performed by human being or machine, increases the cost of child protection. In addition, such purported solutions have the drawback of being inherently retroactive rather than preemptive. That is, while a violator may be sanctioned and thus prevented from performing (under the same on-line identity) a subsequent violation, the initial violations of any users, and even the repeat violations of users acting under new on-line identities, may not be prevented. Accordingly, the protection afforded the child users under such regimes may be deemed inadequate, at least by some parents.

Accordingly, it would be useful to provide child protection of the sort described above but that is more robust, in the sense of eliminating inappropriate or unsuitable on-line interaction or communication in a preemptive manner to the extent possible. It would also be useful to reduce the cost of providing such online child protection.

### SUMMARY OF THE INVENTION

The technology features a computer program product and method that can be used to control a virtual environment. An agent can be required to authorize access to restricted content that a user can request to view. By requiring an agent to authorize what can be viewed by the user, the technology can be used to prevent the user from accessing inappropriate materials and communicating with unknown individuals. The agent can be assured that the user will not be able to do so even without constant supervision.

The technology, in one aspect, features a computerized method of controlling a user's virtual environment by an agent. The computerized method can provide, over a communications network, a plurality of virtual environments in which the user can interact with other users using electronic messaging. An authentication server can transmit information about the plurality of virtual environments to a first computing device associated with the agent in response to the user's request for access to a restricted electronic messaging format associated with one of the virtual worlds. The authentication server can receive an indication of authorization from the first computing device. The indication of authorization can include a separate indication of authorization associated with each of the plurality of virtual environments.

In a further aspect, the technology features a computerized method that can provide, by an authentication server, a dashboard-style interface that can have a first worksheet, a second worksheet, a third worksheet, and a fourth worksheet to display on a computing device associated with an agent. The authentication server can select a first set of information that can be displayed on the dashboard based on criteria preselected by the agent. A second set of information can be provided by a user who can be associated with the agent. A third set of information can be associated with electronic publication subscriptions selected by the user. A fourth set of information can be associated with changes made by the user to the one or more virtual world user accounts. The authentication server can transmit the first set of information that can be displayed on the first worksheet. The second set of information can be displayed on the second worksheet. The third set of information can be displayed on a third worksheet. The fourth set of information can be displayed on a fourth worksheet.

An aspect of the technology also features a computer program product the can be tangibly embodied in a machine-readable storage device. The computer program product can include instructions being operable to cause a data processing apparatus to provide, over a communications network, a plurality of virtual environments in which a user can interact with other users using electronic messaging. An authentication server can transmit information about the plurality of virtual environments to a first computing device that can be associated with an agent in response to the user request for access to a restricted electronic messaging format that can be associated with one of the virtual worlds. The authentication server can receive an indication of authorization from the first computing device, wherein the indication of authorization can include a separate indication of authorization that can be associated with each of the plurality of virtual environments.

The technology, in another aspect, features a computer program product that can be tangibly embodied in a machine-readable storage device. The computer program product can include instructions being operable to cause a data processing apparatus to provide, by an authentication server, a dashboard-style interface that can have a first worksheet, a second worksheet, a third worksheet, and a fourth worksheet that can be displayed on a computing device associated with an agent. The authentication server can select a first set of information that can be displayed on the dashboard based on criteria preselected by the agent, a second set of information provided by a user who can be associated with the agent, a third set of information that can be associated with electronic publication subscriptions selected by the user, and a fourth set of information that can be associated with changes made by the user to the one or more virtual world user accounts. The authentication server can transmit the first set of information that can be displayed on the first worksheet, the second set of information that can be displayed on the second worksheet, the third set of information that can be displayed on a third worksheet, and the fourth set of information that can be displayed on a fourth worksheet.

In some embodiments, the virtual environments can be associated with one or more publications. The authentication server can receive a second indication of authorization that can be associated with subscriptions to the one or more publications.

In some embodiments, the information can include at least one of information for an account that can be associated with the user or information for an account that can be associated with the agent.

In some embodiments, a message checker can prevent electronic messaging that comprises certain combination of predetermined or unpredetermined messages in interactions between users.

In some embodiments, a message checker can exclude content that includes personal identification of the user and contents deemed inappropriate for the user based on an indication of authorization.

In some embodiments information can be transmitted to an agent by email.

In some embodiments, a user is a child and an agent is a parent of the child.

In some embodiments, an email can be transmitted to an email address associated with the agents when updates are made to the first set of information, the second set of information, the third set of information, and a fourth set of information.

In some embodiments, a SMS formatted message can be transmitted to the computing device associated with the agent when updates are made to the first set of information, the second set of information, the third set of information, and a fourth set of information.

In some embodiments, the authentication server can request information associated with the computed device so that the computing device can be registered with the authentication server. The authentication server can receive information associated with the computing device such that the SMS formatted message can be transmitted to a registered computing device.

According to other aspects of the present technology, there are provided systems and computer program products corresponding to the above-described methods.

Further features and advantages of the present technology as well as the structure and operation of various embodiments of the present technology are described in detail below with reference to the accompanying drawings.

### BRIEF DESCRIPTION OF THE DRAWINGS

The features and advantages of the present technology will become more apparent from the detailed description set forth below when taken in conjunction with the drawings.

FIG. 1 is a flow chart illustrating operation of a dictionary mode of communication, according to an example embodiment of the technology.

FIG. 2 is a flow chart illustrating operation of parental controls, according to an example embodiment of the technology.

FIG. 3 is a schematic diagram of an exemplary computer system useful for implementing the present technology.

FIG. 4 is a graphical user interface illustrating user updates that an agent can view and control, according to an illustrative embodiment of the technology.

FIG. 5 is a graphical user interface illustrating user settings that an agent can view and control, according to an illustrative embodiment of the technology.

FIG. 6 is a graphical user interface illustrating user subscriptions that an agent can view and control, according to an illustrative embodiment of the technology.

FIG. 7A is graphical user interface illustrating an agent's settings, according to an illustrative embodiment of the technology.

FIG. 7B is a graphical user interface illustrating additional agent's settings, according to an illustrative embodiment of the technology.

FIG. 8 is a graphical representation of a communication network that uses an authentication server to update and verify settings for a user that are set by an agent.

FIG. 9 is a flow chart illustrating how a dashboard-style interface is provided for implementing the present technology, according to an illustrative embodiment of the technology.

FIG. 10 is a flow chart illustrating how a user can change access permission for implementing the present technology, according to an illustrative embodiment of the technology.

### DETAILED DESCRIPTION OF THE TECHNOLOGY

The present technology is directed to a system, method and computer program product for controlling a virtual environment of a user. The present technology is now described in more detail herein in terms of the above exemplary description. This is for convenience only and is not intended to limit the application of the present technology. In fact, after reading the following description, it will be apparent to one skilled in the relevant arts how to implement the following technology in alternative embodiments.

To the extent that the details of elements or aspects of example embodiments of the technology are not included in the subsequent discussion, it is understood that such details would be known to those of skill in the relevant arts.

Example embodiments of the present technology are intended to be of particular utility in a virtual environment such as an environment of the Internet, in which multiple users interact, but they are not limited to such environments. Example embodiments of the present technology are also intended to be of particular utility for controlling an environment of one or more children, but their applicability is not limited to such users.

In what follows, an example embodiment of the present technology as applied to Nickelodeon's Nick Club, a particular environment on the Internet, will be explained with reference to the figures. Application of this and other example embodiments is not limited to this or the like environments. While the term “system” is at times used in the below description, it is understood that the below description is a description of an example embodiment of the present technology and may, but does not necessarily, apply to any or all embodiments of the technology.

The description of Nick Club and Nick.com given below is merely a partial description and is intended as an example, to facilitate understanding of this example embodiment of the technology and a background or context in which it may be used. This description is not intended to be limiting or comprehensive; rather, in the interest of brevity, a limited number of aspects of Nick Club and Nick.com are described, while other aspects and variations have been omitted.

Nick Club is an immersive three-dimensional virtual world that has a variety of interactive activities oriented toward children or young people. Upon registering at Nick Club, a user acquires a nickname, an avatar and a personal room, each of which may be decorated by the user. The user may visit different virtual venues, such as other users' personal rooms, common spaces such as amusement parks or stores (where users can buy furnishings for their respective personal rooms, for example), virtual versions of TV shows, etc. The user may interact with other users and with Nickelodeon fictional characters in real time. Users use their respective avatars to access different virtual venues and to interact with others.

Nick Club is a part of the Nick.com website, which also contains other features such as games, videos, newsletters, etc. Users of Nick Club can also access these other parts of Nick.com.

Nick Club users can communicate with each other by sending messages. Messages can be sent to an individual user or to the public, e.g., all the users located in the same (instance of a) room in which the user is located. (Although not necessarily evident to the user, multiple instances of rooms may be provided by the system to accommodate large numbers of users, since only a limited number of avatars will physically fit within a given room as seen on-screen.) Nick Club is not necessarily limited to these ways of sending messages.

Nick Club has features for controlling the virtual environment so that it will be safe, comfortable and appropriate for children or young people. Among these features are the methods by which users interact and communicate and the parental controls employed, as will be explained below.

The term “interact” is used herein as a broader term than the term “communicate.” Communication is deemed to be a type or subset of interaction. For example, a user may interact with another user by merely visiting the room of the other user. Communication is understood to refer prototypically, though not necessarily exclusively, to the transmission and receipt of messages.

The term message is to be understood in as broad as possible a sense. In this example embodiment, a message is made up of language, e.g., one or more words. However, it would be possible for a message to be made up of some other bearer of meaning or semantic content, e.g., an emoticon. Further, it would be possible for a message to be made up of, e.g., a punctuation mark, such as an exclamation point, or for a message to be simply a blank or empty message, either of which might arguably be said not to have semantic content.

The term “dictionary,” used below, is not to be deemed restrictive, but can also refer to lists or other structures capable of serving the functions described herein.

In this example embodiment, communication may be carried out in two distinct modes. A first mode may be referred to as “prewritten message” mode, and a second mode may be referred to as “dictionary” mode.

In prewritten message mode, a user communicates with another user or users by selecting a predetermined or prewritten message from a prewritten message dictionary and sending the selected message to the other user(s). In order to provide a virtual environment that is safe, comfortable and appropriate for children or young people, the prewritten message dictionary contains a limited set of complete messages that are deemed appropriate or suitable for the intended users. Examples of prewritten messages could be “hi,” “bye bye,” “'that's fun,” “Let's go to the haunted house,” etc. The messages in the prewritten message dictionary may exclude material that is obscene, violent, threatening, suggestive, offensive, etc. The messages in the prewritten message dictionary may also exclude material that would permit personal identification of a user. For example, the prewritten message dictionary may omit proper names (e.g., names of people or places), words indicating streets such as “street,” “lane,” “road,” etc., numerals (whether written as numbers or spelled out), individual letters (other than those that are words such as “a”), etc. As an exception to the general omission of proper names, the prewritten message dictionary may include the names of fictional characters, such as but not necessarily limited to characters that exist in the virtual environment with whom it may be possible for a user to interact. In view of these limitations of the contents of the prewritten message dictionary, for the purposes of this application the prewritten message dictionary will be said to contain only “acceptable” items.

The above description of the contents of the prewritten message dictionary is provided as an example and is not to be taken as limiting. The contents of the prewritten message dictionary may include items not included therein according to the above description, and the contents of the prewritten message dictionary may exclude items included therein according to the above description. The contents of the prewritten message dictionary may be varied from the contents as described above in any of a variety of ways, as will be understood by one of ordinary skill in the art in view of the description herein.

In a case where the virtual environment, or a part thereof, to which this example embodiment of the technology is applied, were intended for the use of children within a certain age range, the contents of the prewritten message dictionary may be modified accordingly. For example, an application geared toward middle school aged children may warrant prewritten message dictionary contents different from those of an application geared toward pre-school children, since certain subject matter deemed inappropriate for pre-school aged children may be deemed not inappropriate for middle school aged children, etc.

The prewritten message dictionary may be accessed by clicking on a button or tab indicating the prewritten message mode or prewritten message dictionary, which action would cause a pull-down menu of prewritten messages to appear on the user's screen. The user may then select and send a particular prewritten message from the pull-down menu by clicking on the message.

The system may be arranged so that clicking the button or tab initially accesses a pull-down menu of categories of message types, and clicking on one of the categories accesses a pull-down submenu of prewritten messages within that category. Examples of categories could be “openers,” “closing lines,” “summer,” “Nick Shows,” “My mom,” etc. It is not necessary to have multiple levels of menus, and it is possible to have more than two levels (i.e., more than just one menu level and one submenu level).

Alternate ways of accessing the prewritten message dictionary, of selecting a category or prewritten message, of sending a prewritten message, and of structuring the contents of the prewritten message dictionary or categories thereof may be employed, as will be understood by one of ordinary skill in the art in view of this description.

In contrast to prewritten message mode, in dictionary mode, a user communicates with another user or users by composing a message and sending the composed message to the other user(s). The user may accomplish this by clicking on a tab or button indicating the dictionary mode, then typing a message in a field provided on the screen for composing a message, and then hitting return to send the message. Alternate ways of composing and sending a message may be employed, as will be understood by one of ordinary skill in the art in view of this description. (A message composed by a user in dictionary mode may be referred to as a message in dictionary mode, as an unpredetermined message, an unprewritten message, or the like terminology, or simply as a message, when the context makes further specification unnecessary.)

In order to provide a virtual environment that is safe, comfortable and appropriate for children or young people, in dictionary mode there is provided a system dictionary containing a limited set of words or items deemed appropriate or suitable for the intended users. In composing a message, a user is restricted to using only words or items contained in the system dictionary. As was the case with the prewritten message dictionary, the system dictionary may omit material that is obscene, violent, threatening, suggestive, offensive, etc., as well as material that would permit personal identification of the user, such as proper names, words indicating streets, numerals, individual letters, etc., as described above with respect to the prewritten message dictionary. Again, as described above with respect to the prewritten message dictionary, the system dictionary may yet include names of fictional characters, such as characters that exist in the virtual environment. In view of these limitations of the contents of the system dictionary, for the purposes of this application the system dictionary will be said to contain only “acceptable” items.

The above description of the contents of the system dictionary is provided as an example and is not to be taken as limiting. The contents of the system dictionary may include items not included therein according to the above description, and the contents of the system dictionary may exclude items included therein according to the above description. The contents of the system dictionary may be varied from the contents as described above in any of a variety of ways, as will be understood by one of ordinary skill in the art in view of the description herein.

As described above with respect to the prewritten message dictionary, in a case where the virtual environment to which this example embodiment of the technology is applied were intended for the use of children within a certain age range, the contents of the system dictionary may be modified accordingly.

In dictionary mode, the system may also employ a “phrase checker” or “message checker” (these terms are used interchangeably herein). The message checker checks combinations of words composed by a user. While the user in composing a message is restricted to words or items that are contained in the system dictionary and that therefore are “acceptable,” it would in theory be possible to combine two or more acceptable words or items to create a combination that is inappropriate (e.g., obscene, violent, threatening, suggestive, offensive, etc. language, or material that would permit personal identification of the user). As a hypothetical example, while the system dictionary could contain the words “bug” and “off,” the combination “bug off” may be deemed rude and hence inappropriate. In such case, the phrase checker would bar the usage of this combination. Thus, while the system dictionary restricts the corpus of individual words or items available to the user, the phrase checker restricts the corpus of combinations of words or items available to the user. In this sense, the message checker is itself like a dictionary, although operating at a different level of message content, as it were, than the system dictionary. Accordingly, reference may be made herein to a message (or phrase) checker dictionary, since the system may be considered to be acting as if it contained such a dictionary, even though the system need not be structured in such a fashion as to actually have such a dictionary.

It is understood that a variety of ways of implementing the system dictionary and message checker may be employed, as will be understood by one of skill in the art in view of this description.

In order to execute the content restrictions of the system dictionary and phrase checker, the system may operate so as to prevent a user from typing a barred word or combination. For example, assuming that “China” were excluded from the system dictionary as a proper name but that “chin” were included in the system dictionary as an appropriate word, the system would permit a user to type “chin,” but would not then let the user type “a” to form “china” from “chin.” (In one example embodiment, all letters of the alphabet are available only in lower case, or only in upper case, but not in both, although it is possible to have letters available in both upper and lower case.) Again, according to the previously discussed hypothetical example, the system may let the user type “bug of,” an acceptable combination, but would not let the user then type “f” to form “bug off.”

In some cases, an unacceptable word or combination may be part of a longer word or phrase that is acceptable. In this case, the system would let the user type the unacceptable word or combination, but would not let the user send a message containing it. For example, assuming that the item “USA” was excluded from the system dictionary as a proper name while the item “usage” was included in the system dictionary, the system would permit the user to type “usa” as forming the first portion of “usage,” but would not let the user send a message containing “usa.”

Not only may the system prevent a user from typing (completing) a barred word or combination, but the system may prevent a user from typing (completing) any item or portion of an item not contained in the system dictionary and message checker dictionary. For example, assuming the item “Senegal” was excluded from the system dictionary as a proper name, the system may prevent a user from typing “sene” as the beginning of a word if the system dictionary contained no items beginning with that letter combination. Thus, even though “sene” has not been excluded from the system dictionary on grounds of being personally identifiable information (e.g., a proper name, etc.) or inappropriate language (e.g., offensive, violent, threatening, etc.), yet it may still be excluded as not constituting a word or part thereof in the language, or as constituting a word at such a level of sophistication as would not be needed by the target users. Thus, despite the above use of the term “acceptable” to characterize the contents of the system dictionary, the system dictionary may yet exclude language that is perfectly socially acceptable, such as but not limited to language that is too advanced for use by children, language that is meaningless in the language, etc.

As to how the content restrictions of the system dictionary and phrase checker are executed, i.e., how a user is prevented from sending a message the contents of which are not acceptable, a variety of ways of implementing this function may be employed, as will be appreciated by one of skill in the art in view of this description.

An auto-complete feature, according to which, e.g., completed word choices are shown in a pull-down menu, may but need not be provided for dictionary mode. If an auto-complete feature is provided, it may be arranged so as to work in conjunction with the content limitations of the dictionary and message checker. Thus, the auto-complete feature would show only possible word completions that are contained in the system dictionary and not barred by the message checker. The auto-complete feature can be particularly useful where the user has typed one or more letters and the system prevents the user from typing certain additional letters because typing any of those letters would yield a barred word or combination. To take up an earlier example, where the user types “sen,” the system may permit the user to type, e.g., “d” or “t,” but not “e.” In this situation, where the user tries to type “e,” no letter would appear on the screen; however, the auto-complete feature would show the user some or all possible choices of completed words the user can type, thus assisting the user to proceed.

The richness or intelligence of an auto-complete feature, e.g., whether it shows all possible word completion choices or only a selection of choices based on, e.g., contextual considerations, may be varied as desired. This and all other aspects of an auto-complete feature, including its mode of operation and how it is implemented, and the range of possible variation of such aspects, are understood to be known to one of ordinary skill in the art in view of this description.

In the above discussion, the contents of messages and of the system dictionary have often been described as, e.g., words of a language. As words of language are understood to be a representative example of message and system dictionary contents, this terminology has been used for the sake of convenience, but it is not to be taken as limiting the message and system dictionary contents of embodiments of the technology to, literally, words of a language. As noted above, such items as emoticons, punctuation marks, or blanks, could be contents of messages and the system dictionary. In other example embodiments, numerals could be such contents. Symbols of other symbol systems could be such contents. Non-symbolic entities or not necessarily symbolic entities, such as pictures or other graphic or illustrative items, could be such contents. The term “item” has been used above in an attempt to encompass the greatest degree of generality to represent the breadth of the range of possible contents of messages and the system dictionary. Likewise, the term “combination” (as a shorthand for “combination of items”) has been used in an attempt to encompass the same degree of generality.

The term “combination of letters” was used above for convenience to illustrate an aspect of the operation of the system. However, as with the term “word,” the term “letters” is likewise not to be taken as limiting embodiments of the technology to literally (e.g., alphabetic) letters as the necessary components or building blocks of a word or item. The term “sub-item” may be conceptually substituted for “letter,” but for the sake of convenience will not be actually used herein. The term “character” may be used as an attempt to capture the greatest possible generality in this regard.

After the user has selected a prewritten message or has composed a message in dictionary mode, the user may send it to one or more other users. The system may be arranged so that sending a message is accomplished by, e.g., clicking a “send” button on screen, or merely hitting return. The system may be arranged so that, after the user has performed the operation to send the message, the message appears in a balloon or bubble on the screen. The message balloon may be shown as being attached to the user or otherwise indicate the user as its source, for example, by causing both the message and the user (source) to turn a certain color. The message balloon may shown as emanating from the user (source) and then floating elsewhere on the screen, e.g., ascending upward to the top of the screen and then disappearing from sight as having crossed the edge or boundary of the screen. The message balloon may remain on the screen for a fixed period of time, or until a certain triggering event occurs, such as the transmission of another message. The time limit for the message to remain displayed may be appropriately set as some combination of an absolute time limit and an event-triggered time limit, so that the message remain displayed until a certain triggering event, but not before the expiration of a fixed minimum time period. How a message is sent and communicated to one or more others, e.g., how this is performed by a user, how it is executed by the system, and how it appears on the screen, etc., and possible variation in the same, is understood to be known to one of skill in the art in view of this description.

As noted above, it is possible to direct a message to different sets of addressees. For example, a user may send a message to another specific individual user, to several specific individual users, or to a group of users, such as all the users in a room or venue, etc. It is possible to arrange the system so that messages could be sent to other types of sets of addressees.

In this example embodiment, if a user wishes to send a message to another specific individual user, the user selects that other user and then sends the message. The user may select the other user by, e.g., clicking on the other user, so as to cause the other user to be highlighted on the screen. Highlighting may consist in, e.g., changing of the color or brightness of the highlighted object. By so selecting the other user, the message subsequently sent by the user may be directed by the system to the other user. For example, the message balloon may be given a certain color to indicate that it is being sent to the specified other user, or merely that it is being sent to another individual user, or the like. Sending a message to several specific individual other users could be accomplished in similar fashion, e.g., by selecting each targeted user individually. If the user wishes to send a message to a group of users, such as all the other users in the room in which the sender is located, the user simply sends the message without selecting other users. The message balloon may be color coded to indicate that it is being sent to everyone in the room and not to anyone in particular. The selection of addressee(s), e.g., how this is performed by a user, how it is executed by the system, and how it appears on the screen, etc., and possible variation in the same, is understood to be known to one of skill in the art in view of this description.

The sending and receipt of messages as described above is deemed a representative but not necessarily the sole way in which users “communicate” with one another. The term “communicate (with)” is not to be taken as being limited by a requirement that there be two parties (e.g., sender and recipient) to a communication, nor by a requirement as to the nature, or number, of addressee(s). For example, either a user's sending of a message, without reference to the issue or question of addressee/recipient, or a user's receipt or reading of a message, without reference to the issue or question of sender/transmitter, may in itself be deemed communication.

As described above, the dictionary and message checker may be viewed as systems for controlling a virtual environment so as to be safe, comfortable and appropriate for children or young people. In addition to such systems, the virtual environment may also be so controlled by the use of parental controls. Parental controls may be used, e.g., to set, or limit, the levels of interaction and communication at which a user may act in the virtual environment. In this example embodiment, these levels are defined in terms of the range or set of other users with whom the controlled user may interact and communicate (as will be explained in more detail below). However, the levels may be defined differently, e.g., by defining the ranges or sets of other users differently, or more fundamentally, the levels need not be defined in terms of ranges or sets of other users. In addition, the number of levels may be varied from what is described below, e.g., so as to have more gradations of levels. (While the terms “parent,” “child,” and the like are used herein for convenience, they are not to be taken as limiting embodiments of the technology to require that exclusively the parent(s) of a child exercise the parental controls described herein. For example, someone other than a parent could exercise the parental controls, and someone other than a child, or child of the parent, could be subjected to the parental controls.)

As a preliminary to elaborating on the parental controls, the different levels of interaction and communication employed in this example embodiment will be described.

Within the dictionary mode, there are in this example embodiment two levels of communication (which may also be referred to as submodes). A first level of communication permits a user to communicate in dictionary mode with only those other users whom the user has selected or, more specifically, whom the user has placed on the user's nickname list. (In the Nick Club, this level of communication is called “Nick Safe Chat with My NickNames Only.”) The system may be designed so that while operating at this level of communication, a user may still communicate in prewritten message mode with users not selected, i.e., users not on the user's nickname list. A second level of communication of dictionary mode permits a user to communicate in dictionary mode with all registered users. (In the Nick Club, this level of communication is called “Nick Safe Chat.”) The system may be designed so that while operating at this level of communication, a user may also communicate in prewritten message mode with all registered users.

In prewritten message mode, there is only one level of communication (submode): users may communicate with all registered users.

As noted above, the category “communication” is to be here understood as a subset of the category “interaction.” One way in which users can interact other than by the prototypical communicative acts of sending and receiving messages is by visiting the personal rooms of other users. (A user's personal room may also be referred to herein as a virtual space designated for the user.) With respect to visiting personal rooms, or room access, in this example embodiment three levels of interaction (or submodes are defined). At a first level of interaction, a user's personal room is closed to all other users, i.e., no one except the user is allowed to enter the user's own personal room. (In the Nick Club, this level of interaction is called “Closed.”) At a second level of interaction, the user as well as those other users whom the user has selected or, more specifically, whom the user has placed on the user's nickname list may enter the user's personal room. (In the Nick Club, this level of interaction is called “My NickNames Only.”) At a third level of interaction, the user and all other registered users may enter the user's personal room. (In the Nick Club, this level of interaction is called “Everyone.”)

The term “registered user” is to be understood in contrast to “guest.” A guest is an unregistered or temporarily registered user. In this example embodiment, guests are not permitted to chat with registered users or to visit the personal rooms of registered users. The access or range of action permitted to guests could be modified, as will be appreciated by one of ordinary skill in the art in view of this description.

Each user is provided with a nickname list, on which the user can place the nicknames of other users. The system may be arranged, e.g., so that one's nickname list can be accessed, e.g., by clicking on a button indicating the nickname list, or, e.g., so that one's nickname list is constantly shown on the screen. The system may be arranged so that a user can add nicknames to the user's nickname list, e.g., by typing the names onto the list, or, e.g., by clicking on the avatar of the user to be added to the list. Removal of nicknames from one's nickname list could be accomplished by, e.g., clicking on a nickname to be removed and then clicking a remove button. Alternative arrangements of accessing one's nickname list and of adding and removing names from the list are possible, as will be appreciated by one of ordinary skill in the art.

The system may be set to have a default level of communication and a default level of interaction, i.e., levels at which the user is controlled if the parent exercises no overriding of the initial setup of the virtual environment. In this example embodiment, the default level of communication is the level of prewritten message mode, and the default level of interaction is “My Nicknames Only.” The defaults could be varied, as will be appreciated by one of ordinary skill in the art in view of this description.

In this example embodiment, the parental controls operate as follows. When a user, e.g., a child, registers at the Nick Club, the user is permitted to act at the default levels. That is, the user is permitted to communicate in the prewritten message mode with all registered users, and only the user and registered users on the user's nicknames list are permitted to visit the user's personal room. The user is also permitted to change the room access setting (i.e., the level of interaction) to the most restrictive setting, namely, “closed.” It may also be noted that the user also has the option to turn the chat feature off altogether (or back on) at any time during any session.

If the user wishes to act at a less restrictive level than the default levels, the user must obtain permission from the parent, that is, must have the parent log in and override the default settings. This is done as follows. If the user enters a request to change a setting (level) to one requiring parental consent, then the system asks the user to enter the parent's email address. (The term “request” and the like terms as used throughout this application are to be understood in the broadest possible sense. A request need not be direct, explicit, or the like, and does not necessarily require the requester's intention or knowledge of making the request. In the above situation, the request entered by the user could be an explicit request to effect a parental override of the current setting. Alternatively, it could be a request to change the current setting to a setting requiring parental override (regardless of whether the user is aware that the requested setting requires parental override), which request triggers the transmission of a request to the parent to effect parental override of the current setting. Still alternatively, the request entered by the user could be a different action/event or series of actions/events.)

After the child enters the parent's email address, the system sends an email to the parent's email address. The email contains information including at least an authorization code or the like item. The information may also include, e.g., a description, addressed to the parent, of the Nick Club, or the environment in question in which the child is operating, the different levels, and the child's request. The term “information” is to be understood in the broadest possible sense.

The parent can access and log into the Nick Club as a parent of the child by using the authorization code or the like item. The parent may be asked to enter his or her email address and/or create a password, which may be used instead of the authorization code or the like item for future logging in by the parent.

Once the parent has logged in, the parent may access the parental controls. Using the parental controls, the parent can override the default or child-selected settings (levels). The parent can select any setting for either chat and/or room access, i.e., any level of communication and/or level of interaction. The parent can select a given setting, e.g., by clicking on the setting. After selecting a setting, the parent can cancel his selection (e.g., to change the selection), or save the selected setting.

If the parent saves the selected setting(s), the system logs the parent out and the currently selected settings (whether changed by the parent from the previously set settings or not) are locked in place. The child cannot unlock the settings, except to change a setting to a default setting or a setting more restrictive than the default setting. In other words, the child cannot select a setting that only a parent can authorize, but rather can select only one of the settings that the child is permitted by default upon initial registration. If the child wishes again to change the setting to a less restrictive setting, the child must get the parent to log in again and make the change. Once the parent has already initially logged in, such second or subsequent request to override the default settings does not involve the sending of an email to the parent's email address. Rather, the child must simply ask the parent to log in and effect the override. Aside from the log in procedure (as noted above), the second or subsequent execution of the procedure of overriding or changing/setting the settings by the parent operates in the same way as the first execution of the procedure.

As will be understood from the above description, the parent, and only the parent, can at will log in, change the settings and lock the changed settings at any time.

The content and operation of the parental controls is subject to a wide range of variation, as will be understood by one of ordinary skill in the art, in view of the description herein. For example, parental involvement could be triggered otherwise than by the child requesting access to a level requiring parental consent. More specifically, for example, the system could be arranged to involve the parent at the outset, e.g., to require the parent to register together with the child initially. For another example, the manner by which information is transmitted or communicated to the parent by the system could be varied from the electronic mail communication described above. For another example, the manner in which the parent accesses the system, including but not limited to the login information the parent uses to do so, could be varied from that described above. For another example, the manner in which the settings are set and locked could be varied from that described above. These examples are not intended to be exhaustive as to what aspects of the parental controls can be varied. It is understood that one of ordinary skill in the art would know how to implement variations such as those set out above as well as those not set out above.

It may be noted that, in a situation in which the parent has not selected dictionary mode, i.e., where the user is operating in the default, prewritten message mode, the system will not display a button or the like to select dictionary mode or a field for composing a message.

Further verification or authentication features or the like, beyond those described above, may be added to the parent control function. For example, upon initial login (sign up) by the parent, the system could ask the parent to input the parent's credit card information or the like, which the system could use to verify the age, personal identity, and/or the like information concerning the parent. If the parent refused to input the requested information, or if the system were unable to verify the information concerning the parent, the parent would be refused access. How to implement such further verification features or the like in the parent control function, and the range of possible variation of such features, are understood to be known by one of skill in the art in view of this description.

This example embodiment provides a number of other features for creating a safe, comfortable and appropriate environment for children or young people. A “record chat” feature permits a user to (retroactively) record a period of chat, for use, e.g., when the user feels another user has acted inappropriately in a chat or when the user feels uncomfortable in a chat with another user. The recorded chat can then be forwarded to and reviewed by pertinent authorities, e.g., a website moderator. A “report a concern” feature permits a user to report a concern at any time to, e.g., a website moderator, for use, e.g., when the user feels another user has acted inappropriately or when the user feels uncomfortable with the behavior of another user. A “block” feature enables a user to place other users on the user's block list, whereby other users are blocked (barred) from chatting with the user. The system may be arranged so that a user can also block other users from entering the user's personal room. The virtual environment may be subject to occasional, random or spot moderating by a moderator to monitor for inappropriate language or behavior. Full moderation is also possible. The system dictionary and phrase checker may also be updated as appropriate to modify their contents. Implementation of these and other features for providing safety and the like, and a wide range of possible variation thereof, is understood to be known to one of ordinary skill in the art.

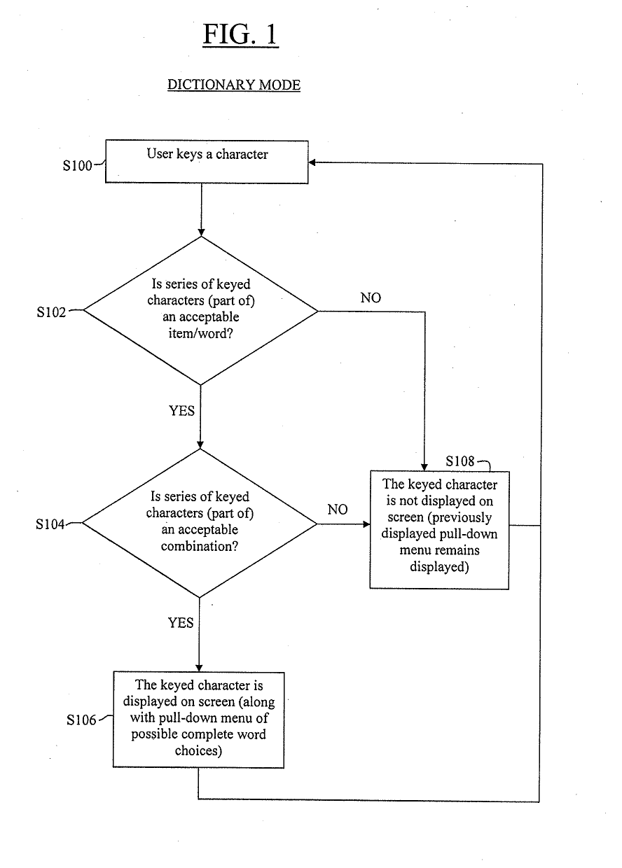

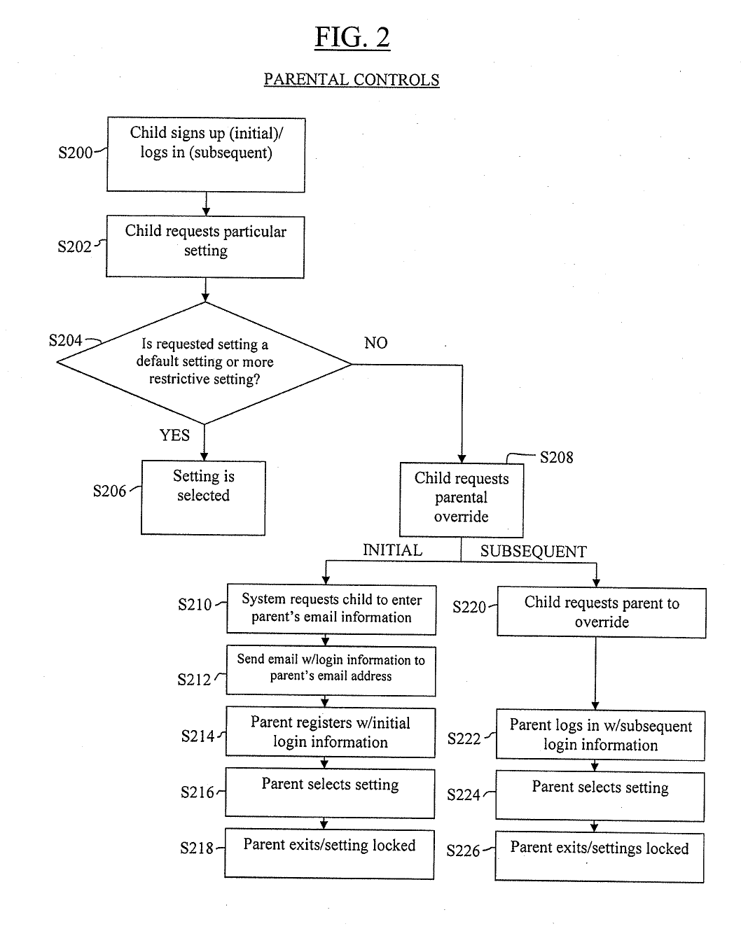

In order to better appreciate example embodiments of the technology, a discussion thereof with reference to the accompanying figures follows. FIGS. 1 and 2 are flow charts illustrating examples of operations of aspects of example embodiments of the technology. Both flow charts may represent simplifications, schematizations, outlines or the like of operational flows or series of steps employed in example embodiments of the technology. Embodiments of the technology may have operational flows or series of steps that are richer, more complicated or modified, as compared to the flows presented in the flow charts.

FIG. 1 is a flow chart illustrating an example of operation of the dictionary mode, i.e. a flow of steps that occur after dictionary mode has been selected by parental override and by the user. The flow illustrates aspects of composing a message, not sending a message. At step S100, a user executes a keystroke on a keyboard by pressing the key for a given character, e.g., letter. At step S102, the system determines whether the series of characters keyed (pressed) so far in the given message (i.e., including the character keyed in step S100) is an acceptable word or item, or a part of an acceptable word or item, i.e., a word or item contained in the system dictionary, or a part of a word or item contained in the system dictionary. If the series of characters keyed so far does so qualify, then at step S104 the message checker of the system determines whether the series of characters keyed so far is an acceptable combination or part of an acceptable combination. If the series of characters keyed so far again qualifies, then at step S106 the character keyed at step S100 is displayed in the field provided on the screen for composing messages in dictionary mode. If the system is provided with an auto-complete feature, then at step S106 a pull-down menu of possible complete word choices is displayed on the screen, or the like auto-complete operation occurs. The user can select a complete word choice if desired. The flow returns to step S100.

Returning to step S102, if the series of characters keyed so far in the given message is not an acceptable word or item, or a part of an acceptable word or item, then the flow proceeds to step S108, at which the character keyed at step S100 is prevented from being displayed. If the system is provided with an auto-complete feature, then at step S108 a pull-down menu of possible complete word choices already on display on the screen (i.e., triggered by the last displayed character), if there is any such pull-down menu already on display on the screen, remains on display on the screen, or the like auto-complete operation already in effect, if any, remains in effect. The user can select a complete word choice if desired. As at step S102, similarly at step S104 if the series of characters keyed so far in the given message is not an acceptable combination or part of an acceptable combination, then the flow proceeds to step S108, at which the character keyed at step S100 is prevented from being displayed and any auto-complete operation already in effect (e.g., pull-down menu already on display on the screen) remains in effect. From step S108, the flow returns to step S100.

FIG. 2 is a flow chart illustrating an example of operation of the parental controls. At step S200, a user, e.g., a child, signs up (in the case of initial use of the system) or logs in (in the case of subsequent use of the system). At step S202, the user requests a particular setting (level of communication or level of interaction). At step S204, the system determines whether the requested setting is a default setting or a setting more restrictive than a default setting. If the setting so qualifies, then at step S206 the setting is selected, i.e., implemented by the system. If the setting does not so qualify, then at step S208 the user requests a parental override in order to select the setting. At this point in the flow, the flow proceeds along either of two paths, depending on whether the session is the user's initial session or a subsequent session.

If the session is the user's initial session, then at step S210, the system requests the user to enter the parent's email information. At step S212, the system sends an email containing login information to the parent's email address. The login information includes initial login (sign up) information for the parent to initially register on the system and may include different subsequent login information for the parent to subsequently log in to the system. Alternatively, the parent may create subsequent login information upon/during initial registration. At step S214, the parent, having received the email containing the initial login information, registers on the system using the initial login information. The initial login information may include an authorization code or the like. After registering, at step S216 the parent selects a setting to set a level of communication and/or a level of interaction for the user. At step S218, the parent exits the parental controls section, which is the section where the parent can select settings. Upon exiting the parental controls section, the setting(s) selected by the parent are saved and locked by the system. That is, the user cannot override (change) the selected setting(s) except to request a default setting or a setting more restrictive than the default setting.

Returning to step S208, if the session is the user's subsequent session, then at step S220 the user requests the parent (e.g., off-line) to override the setting currently in effect (which would be either a default setting or a more restrictive setting) and to select the particular setting selected by the user in step S202. At step S222, the parent logs in using the subsequent login information. By properly logging in, the parental override capability is enabled. At step S224, the parent selects the particular setting selected by the user in step S202, overriding the setting that had been in effect. At step S226, the parent exits and the selected setting is saved and locked, as in the manner of step S218.

It may be reiterated that the term “request” and the like terms (see, e.g., steps S202, S208, S210, and S220) are to be understood in the broadest possible sense, as was discussed above.

Example Implementations

The present technology, or any part(s) or function(s) thereof, may be implemented using hardware, software or a combination thereof and may be implemented in one or more computer systems or other processing systems. However, the manipulations performed by the present technology were often referred to in terms, such as adding or comparing, which are commonly associated with mental operations performed by a human operator. No such capability of a human operator is necessary, or desirable in most cases, in any of the operations described herein which form part of the present technology. Rather, the operations are machine operations. Useful machines for performing the operation of the present technology include general purpose digital computers or similar devices.

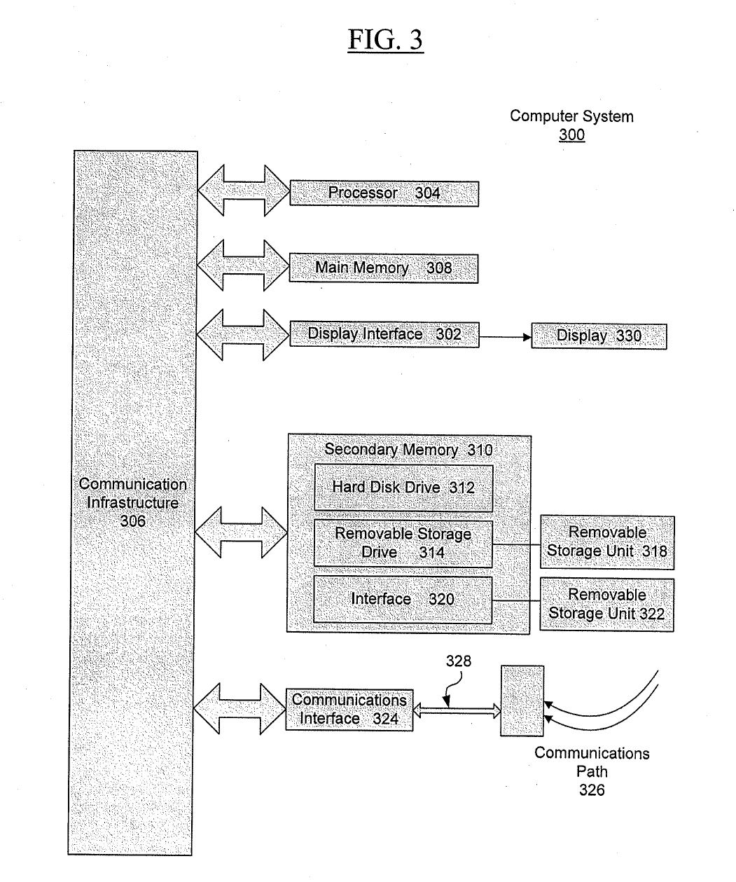

In fact, in one embodiment, the technology is directed toward one or more computer systems capable of carrying out the functionality described herein. An example of a computer system 300 is shown in FIG. 3.

The computer system 300 includes one or more processors, such as processor 304. The processor 304 is connected to a communication infrastructure 306 (e.g., a communications bus, cross-over bar, or network). Various software embodiments are described in terms of this exemplary computer system. After reading this description, it will become apparent to a person skilled in the relevant arts how to implement the technology using other computer systems and/or architectures.

Computer system 300 can include a display interface 302 that forwards graphics, text, and other data from the communication infrastructure 306 (or from a frame buffer not shown) for display on the display unit 330.

Computer system 300 also includes a main memory 308, preferably random access memory (RAM), and may also include a secondary memory 310. The secondary memory 310 may include, for example, a hard disk drive 312 and/or a removable storage drive 314, representing a floppy disk drive, a magnetic tape drive, an optical disk drive, etc. The removable storage drive 314 reads from and/or writes to a removable storage unit 318 in a well known manner. Removable storage unit 318 represents a floppy disk, magnetic tape, optical disk. etc. which is read by and written to by removable storage drive 314. As will be appreciated, the removable storage unit 318 includes a computer usable storage medium having stored therein computer software and/or data.

In alternative embodiments, secondary memory 310 may include other similar devices for allowing computer programs or other instructions to be loaded into computer system 300. Such devices may include, for example, a removable storage unit 322 and an interface 320. Examples of such may include a program cartridge and cartridge interface (such as that found in video game devices), a removable memory chip (such as an erasable programmable read only memory (EPROM), or programmable read only memory (PROM)) and associated socket, and other removable storage units 322 and interfaces 320, which allow software and data to be transferred from the removable storage unit 322 to computer system 300.

Computer system 300 may also include a communications interface 324. Communications interface 324 allows software and data to be transferred between computer system 300 and external devices. Examples of communications interface 324 may include a modem, a network interface (such as an Ethernet card), a communications port, a Personal Computer Memory Card International Association (PCMCIA) slot and card, etc. Software and data transferred via communications interface 324 are in the form of signals 328 which may be electronic, electromagnetic, optical or other signals capable of being received by communications interface 324. These signals 328 are provided to communications interface 324 via a communications path (e.g., channel) 326. This channel 326 carries signals 328 and may be implemented using wire or cable, fiber optics, a telephone line, a cellular link, a radio frequency (RF) link and other communications channels.

In this document, the terms “computer program medium” and “computer usable medium” are used to generally refer to media such as removable storage drive 314, a hard disk installed in hard disk drive 312, and signals 328. These computer program products provide software to computer system 300. The technology is directed to such computer program products.

Computer programs (also referred to as computer control logic) are stored in main memory 308 and/or secondary memory 310. Computer programs may also be received via communications interface 324. Such computer programs, when executed, enable the computer system 300 to perform the features of the present technology, as discussed herein. In particular, the computer programs, when executed, enable the processor 304 to perform the features of the present technology. Accordingly, such computer programs represent controllers of the computer system 300.

In an embodiment where the technology is implemented using software, the software may be stored in a computer program product and loaded into computer system 300 using removable storage drive 314, hard drive 312 or communications interface 324. The control logic (software), when executed by the processor 304, causes the processor 304 to perform the functions of the technology as described herein.

In another embodiment, the technology is implemented primarily in hardware using, for example, hardware components such as application specific integrated circuits (ASICs). Implementation of the hardware state machine so as to perform the functions described herein will be apparent to persons skilled in the relevant arts.

In yet another embodiment, the technology is implemented using a combination of both hardware and software.

In other embodiments, the virtual environment allows users to interact with other users using electronic messaging. Electronic messaging can utilize any type of messaging system, including, but not limited to, email, instant messaging (IM), SMS, and MMS.

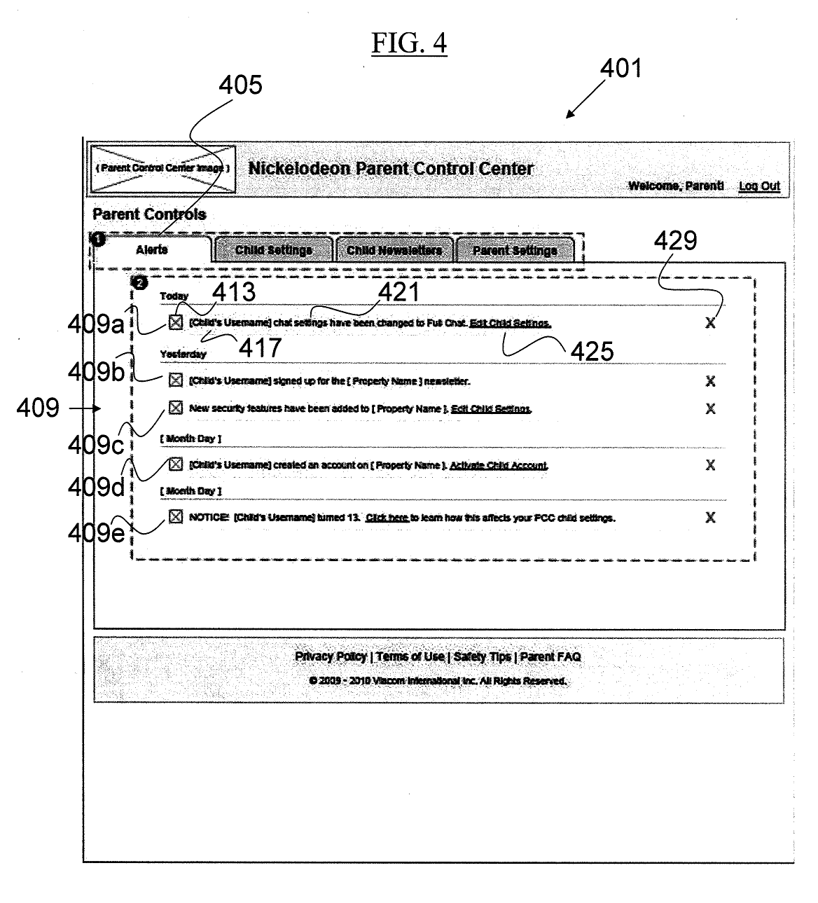

In some embodiments, for example, FIG. 4, a graphical user interface 401 can display a worksheet 405 that presents the user updates 409. The user updates 409 can also be referred to as “alerts.” The graphical user interface 401 can display zero user updates when there are no user updates 409. In other embodiments, there may be any number of user updates. As shown in FIG. 4, the user updates 409 can be arranged by date, e.g., today, yesterday, last month, etc. In some embodiments, the user updates 409 can be arranged by user, if the agent has access, and is monitoring more than one user account

The graphical user interface 401 in FIG. 4 shows user updates 409 that an agent can view and control. The updates 409 can indicate changes that have been made to a user's account by the user, by the agent, or as an automated change for example, as a result of a birthday or as part of updated security features that are added to a property. For example, as shown in FIG. 4, a user update 409a shows that a change has been made to a user's setting. A user update 409b shows that the user has signed up for a new subscription. A user update 409c shows that a security setting has been changed. A user update 409d shows an account created by the user. A user update 409e shows an event status, such as a birthday. In some embodiments, user updates 409 can include a status icon 413, a user name 417, a message 421, a link 425, and a deletion icon 429. The status icon 413 can give the agent a quick way to recognize whether the agent needs to pay particular attention to the user updates 409. The user name 417 can signify which user the user updates 409 refer to. In some embodiments, the agent can view updates from more than one user on first worksheet 405. The message 421 can show the user action. The link 425 can be used to authorize requests or to change settings for a user. The link 425 can require agent action. An example of agent action is shown in the user update 409d where the agent must activate the account created by the user. The deletion icon 429 can be used to delete the user updates 409 so that it will not be displayed when viewing the worksheet 405. The user updates 409 can also show when an agent has provided an indications of authorizations to some usage request from a user.

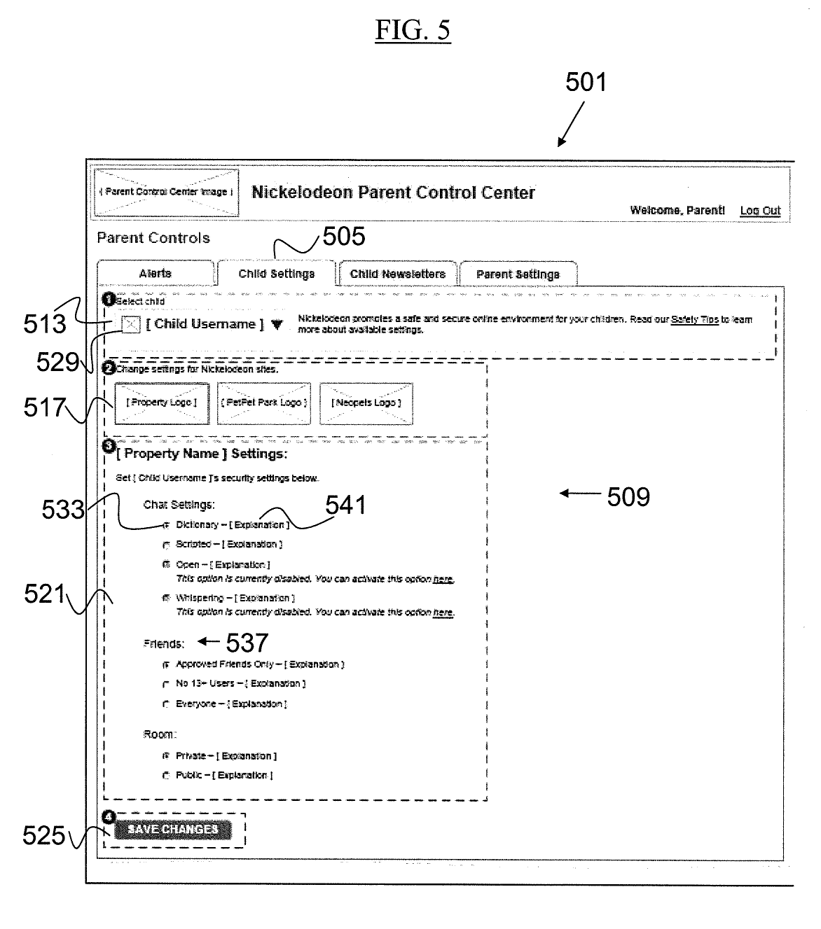

In some embodiments, for example FIG. 5, a graphical user interface 501 can display a worksheet 505 that presents user settings 509. The user settings 509 can be referred to as “child settings.” The graphical user interface 501 can display a user list 513 and list of virtual properties 517. In some embodiments, each virtual property 517 has its own settings page 521. In other embodiments, the worksheet can display property settings for a plurality of virtual properties. The settings for each virtual property 517 can be independent of the setting for other virtual properties that can be controlled using worksheet 505. The worksheet 505 can also contain a save changes icon 525.

The graphical user interface 501 in FIG. 5 shows user settings 509 that an agent can view and control. The agent can select which user's setting is displayed by selecting a user in the user list 513. The user list 513 can list users in alphabetical order. In some embodiments, the user list 513 can display an ID icon 529 to indentify a user. After an agent selects a user from the user list 513, the user's virtual properties 517 can be displayed. The agent can then select one of the virtual properties 517 to display the settings page 521 associated with the selected virtual property. The settings page 521 can allow the agent to view and change a number of options 533 in different categories 537, for example, “Chat Settings,” “Friends,” and “Room.” The agent can then adjust the user's settings 509 to restrict or allow the user access to various functions or options in the different virtual properties. The settings can control functions including privacy settings, who is allowed to view the user's chat rooms, or interact with the user in their chat room. In some embodiments, the settings will also control how the user is able to communicate with other user, e.g., using a pre-written message or using the above described dictionary mode. In some embodiments, when the agent initially views the user's settings, the settings are shown as being set by the user. The agent can then make changes to the user's settings. In some embodiments once the agent sets the user's settings, the user can not reset the user settings to make them less restrictive. In some embodiments, the user can not reset the user settings once the agent has made any changes to the user settings. And in some embodiments, the user can select settings, but can not have access to the virtual property or the new settings until the agent has approved the user's selected or updated settings. Each option 533 can include a description 541 of the option allowing the agent to make an informed decision. The option 533 can be disabled and in some embodiments can require additional action from the agent. In some embodiments, the option 533 can include a visual indication of which option is selected. The option 533 can be, for example, a radio button or a check box. Changes to settings made by the agent can be saved by using the save changes icon 525. In further embodiments, if an agent does not have any associated users, the graphical user interface 501 will be blank. The setting page 509 can also automatically default to the user's setting if only one user is associated with the agent. All user information associated with the agent can be grouped together in an account for the agent.

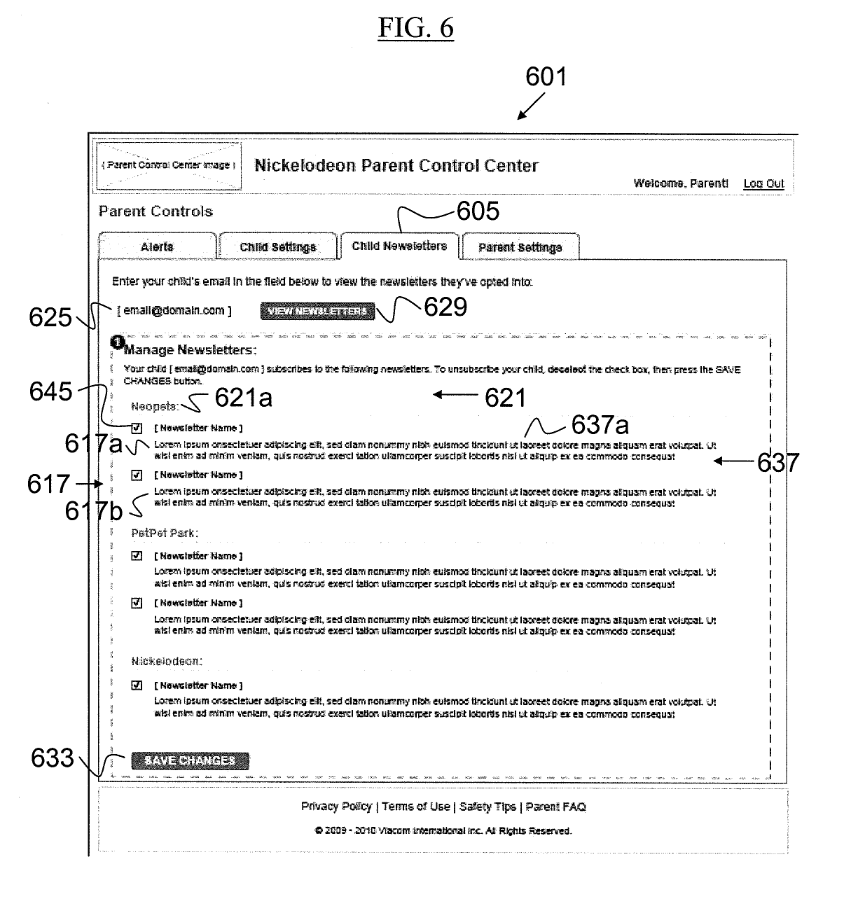

In some embodiments, for example FIG. 6, a graphical user interface 601 can display a child newsletter worksheet 605 that presents user subscription listings 617. An agent can use the child newsletter worksheet 605 to control the user's access to different publications or newsletters that are associated with different virtual environments. In some embodiments, the user will be automatically subscribed to the newsletters or publications when the user creates a profile associated with the virtual environments. In other embodiments, the user will have to affirmatively subscribe to the newsletters or subscriptions. In some embodiments, the worksheet 605 can display a user's contact information 625. The contact information 625 can be, for example, a name or alias, an email address, a postal address, and a telephone number. If there is more than one user, there can be more than one user's contact information. Each of the user's contact information can be associated with its own display icon 629. The agent can choose to show or hide the user subscriptions listings 617 by pressing the display icon 629. In some embodiments, the display icon 629 can be associated with the user's contact information 625. The display icon 629 can be located next to or near the user's contact information 625 when displayed on the worksheet 605. The worksheet 605 can also contain a save changes icon 633. Changes to settings made by the agent can be saved by using the save changes icon 633.

The subscriptions listings 617 can include newsletters, publications, advertisements, magazines, and other distributed documents. Each subscription listing 617 can include a description 637. In some embodiments, each subscription listing 617 can have its own unique description 637. For example, subscription listing 617a can have a description 637a that is unique to subscription 617a. The descriptions 637 can describe the publication or newsletter. In some embodiments, the subscriptions listings 617 are grouped by virtual property name 621. One or more subscription listings 617 can be associated with each virtual property 621. For example, two subscriptions (subscriptions 617a and 617b) are associated with virtual property 621a. In some embodiments, subscription listing 617 can include a visual indication 645 that the subscription listing is selected. The visual indication can be, for example, a radio button or a check box. An agent can use the visual indications to subscribe or unsubscribe a user from one or more publications or newsletters. In some embodiments, the user will select one or more subscriptions and will require that the agent confirm or approve the selection before the user can receive the subscriptions or newsletter. In some embodiments if the agent makes changes to the subscription listings, the user can not reset the subscription listings to make them less restrictive. In some embodiments, the user can not reset the subscription listing once the agent has made any changes to the subscription listing.

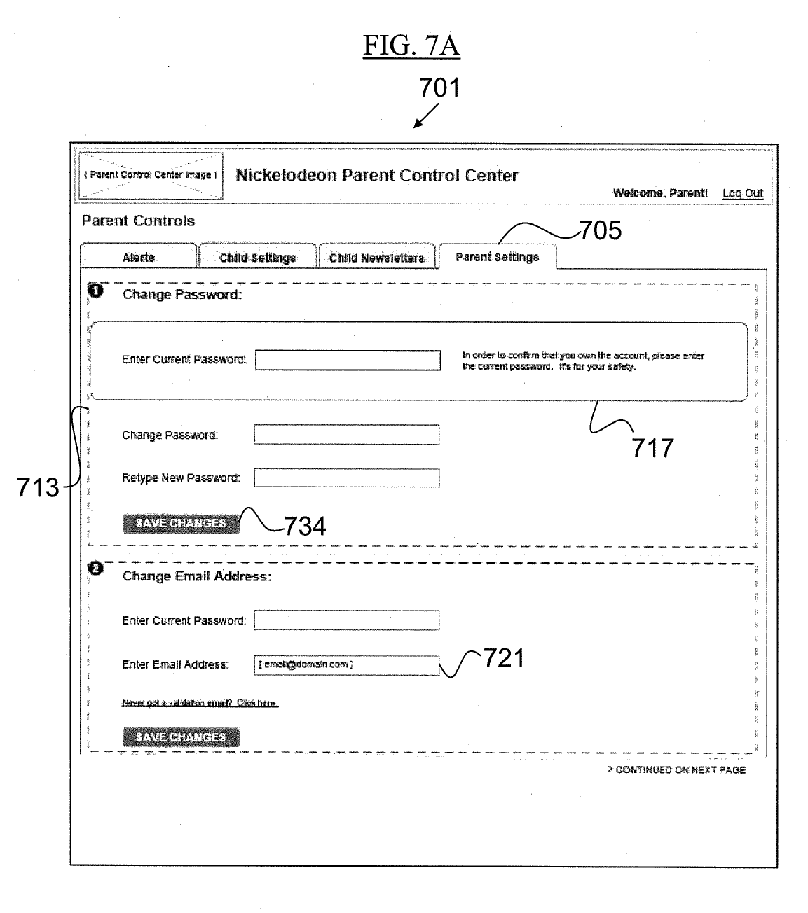

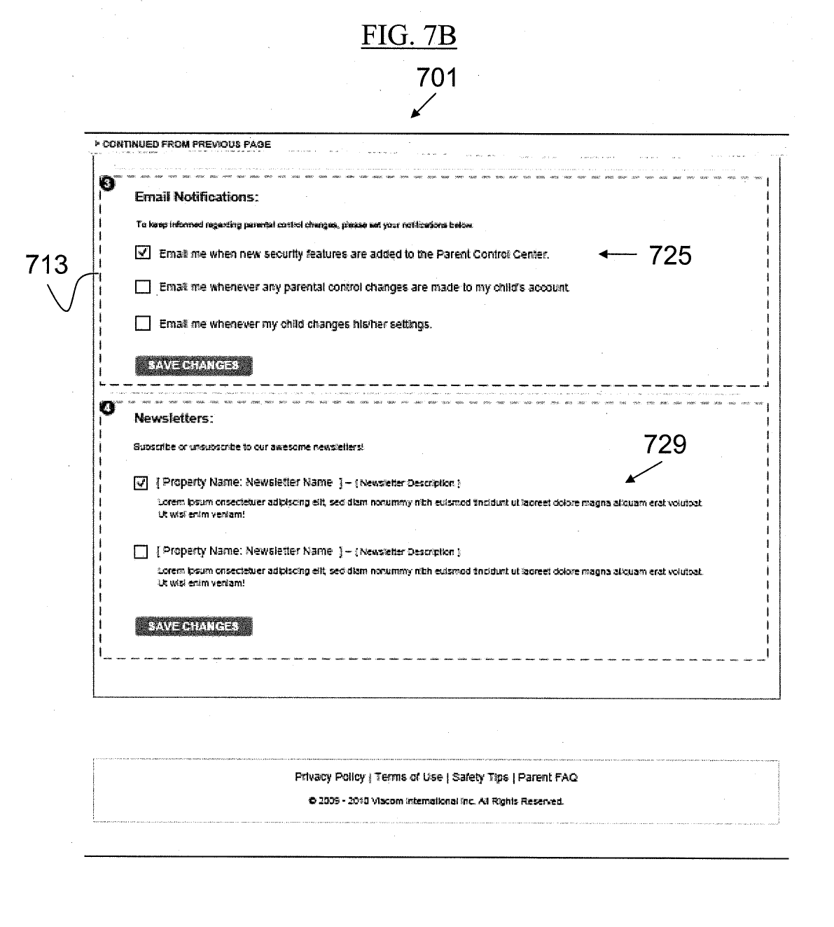

In some embodiments, for example FIG. 7A, a graphical user interface 701 can display a worksheet 705 that presents an agent's settings. The agent's setting can also be referred to as “parent settings.” The worksheet 705 can include a setting window 713. In some embodiments, the graphical interface 701 can display multiple setting windows 713. The setting window 713 can change one or more aspect of the agent's settings that allows them access to the other worksheets, described above

FIG. 7B shows additional setting windows 713 that can be displayed on the worksheet 705. Each setting window 713 can correspond to a specific type of setting that controls the virtual environment. For example, the setting window 713 can be a change password window, a change email address window, an email notifications window, and a newsletters window. For example, the agent settings can include password information 717 and an agent's email address 721. In some embodiments the email address provided by the agent allows the agent to receive email notifications or have alerts forwarded to the designated email address. Alerts can include changes that the user makes to their user settings, changes made to the parental (or agent) controls, changes or updates to the Parental Control Center, or other updates generated by the virtual properties. An agent can control which email notifications they receive by selecting one or more of the types of email notification selection options 725. In some embodiments, the setting windows 713 can include newsletter subscription options 729. The agent newsletter selections can include subscriptions to publications that are specifically directed to agents or parents. In some embodiments the newsletter subscription options can include subscriptions that the user's also have access. And in some embodiments, the agent's subscriptions options can include subscriptions that are directed to parents and subscriptions that are directed to children or users. Any changes that the agent makes to their settings can be saved by using a “Save Changes” icon 734.

In other embodiments, a graphical user interface can contain any number of worksheets based on any number of features. The order in which the worksheets appear on the graphical user interface can be changed or rearranged using any criteria.

In some embodiments, another feature that can be made available to an agent is a “privacy setting.” This setting can, among other features, allow an agent to view a virtual environment as if the agent was the user. This view can allow an agent to test out the virtual environment. In some embodiments, the agent can create and use an account with the identical privileges as the user would have. With either embodiment, the agent can be assured that the virtual environment is set up as the agent envisioned or desired.

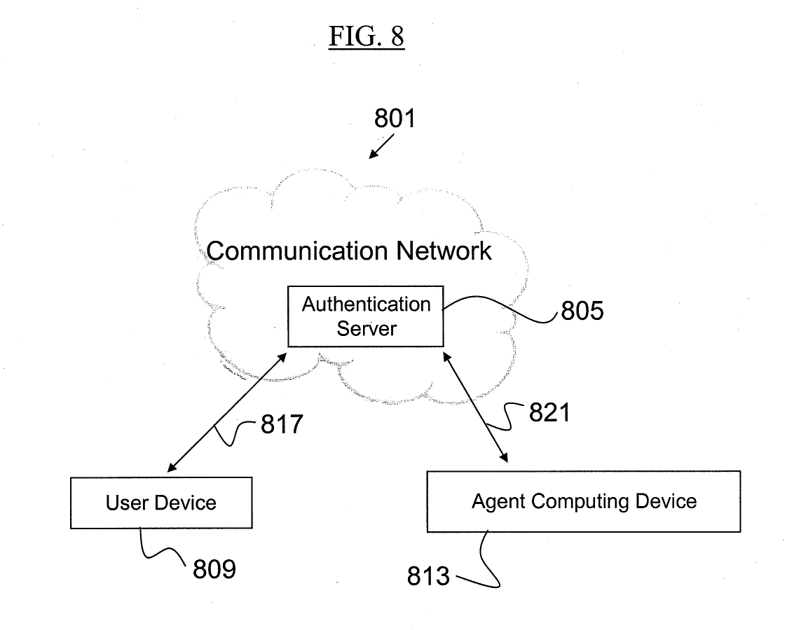

FIG. 8 shows a graphical representation of a communication network 801 that uses an authentication server 805, a user device 809 and an agent computing device 813. User settings are stored in the authentication server 805 and can be cross-checked whenever a user attempts to make any changes to their virtual environment. Whenever a user attempts to make changes to their virtual environment, a setting message 817 can be transmitted between the user device 809 and the authentication server 805. The types of changes to settings can be permission to, for example, receive new subscriptions, connect to other users (who may or may not be associated with the agent), or access restricted features of the virtual environment. The setting message 817 can cause the authentication server 805 to check or verify the stored user settings to see if the user was previously allowed to make the attempted change to their virtual environment. After verifying that the attempted change is allowed under the user settings, the authentication server 805 can authorize the change to the user's virtual environment. The authentication server 805 can also send a setting message 817 to the user device 809 to indicate that permission has been granted for the attempted change. In some embodiments, the user's virtual environment can reflect the changes immediately upon verification. If the user settings do not allow for the attempted change, a permission message 821 can be transmitted between the agent computing device 813 and the authentication server 805. The permission message 821 can ask the agent to allow the attempted changed to be made, subsequently modifying the user settings. The agent, through the agent computing device 813, can edit the settings to allow the requested change by authorizing permission. This will cause the authentication server 805 to save the edited user settings. In other embodiments, the authentication server 805 can prompt the user to decide whether they would like to ask the agent to change their user settings before sending the permission message 821 to the agent. The setting message 817 and the permission message 821 can be an electronic message. The electronic message can be, for example, email, instant messaging (IM), SMS, and MMS.

In some embodiments, the communication network 801 is cloud-based, meaning no setting information is stored on the user device 809. In a cloud-based implementation, each time a user uses the user device 809, the user device 809 must verify user settings with the authentication server 805 before the user can use their virtual environment. In other embodiments, a user device 809 can be registered with the authentication server 805. Registration can be required before a user can use the virtual environments on the user device 809. A setting message 817 can be sent to the user device 809 indicating that it has been registered with the authentication server 809.

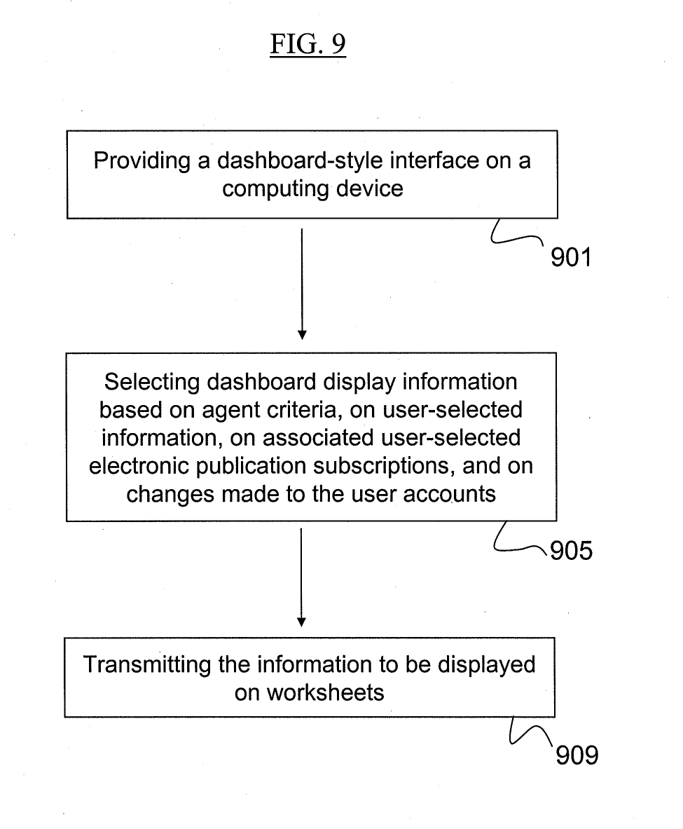

FIG. 9 illustrates a method that implements a dashboard-style interface stylized in the manner shown in the graphical user interfaces 401, 501, 601, and 701 of FIGS. 4, 5, 6, and 7, respectively. At step 901, a user or an agent can request that an authentication server provide a dashboard-style interface on a computing device so that the user or the agent can use the virtual environments. At step 905, the authentication server can select the dashboard display information based on a number of criteria. These criteria can include, for example, agent criteria, user-selected information, associated user-selected electronic publication subscriptions, and changes made to the user accounts. These criteria can be based on any type of settings change that the user may request or that the agent may grant or force upon the user. In some embodiments, the criteria can be preselected by the agent and cannot be changed by the user. At step 909, the authentication server can transmit the information to the graphical user interfaces which can display the transmitted information on a worksheet.

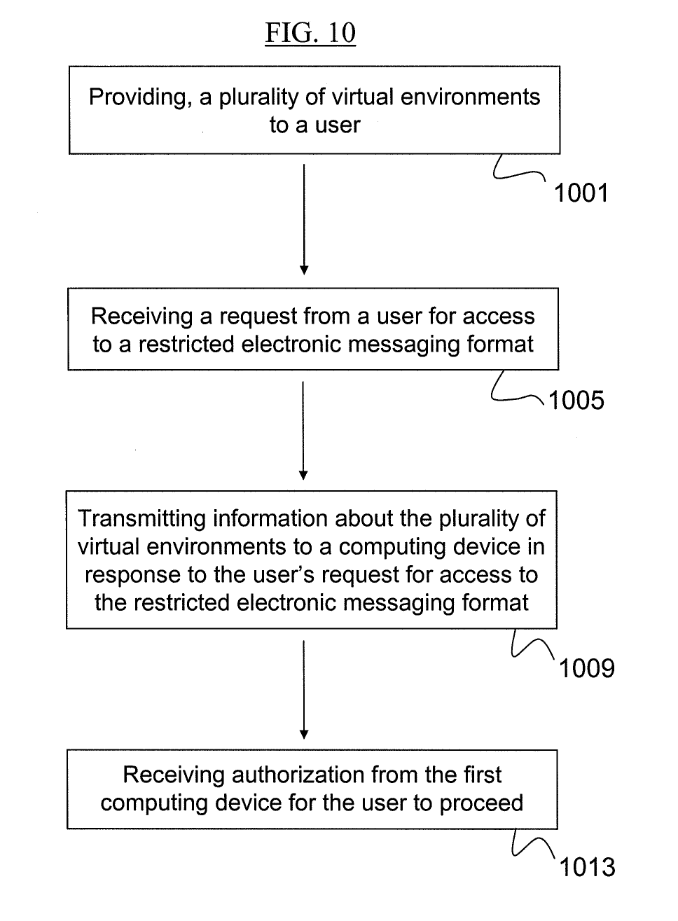

A user can change access permission by utilizing the method displayed in FIG. 10. At step 1001, an authentication server can provide a plurality of virtual environments to a user device so that the user can use the virtual environments, similar to steps 901, 905 and 909. At step 1005, the authentication server can receive a request from the user for access to a restricted electronic messaging format. At step 1009, the authentication server can transmit information about the plurality of virtual environments to a computing device in response to the user's request for access to the restricted electronic message format. At step 1013, the authentication server can receive authorization from the computing device for the user to proceed. In some embodiments, the restricted electronic message format can be any type of subscription or electronic messaging, as described above.

While various embodiments of the present technology have been described above, it should be understood that they have been presented by way of example, and not limitation. It will be apparent to persons skilled in the relevant arts that various changes in form and detail can be made therein without departing from the spirit and scope of the present technology. Thus, the present technology should not be limited by any of the above-described exemplary embodiments, but should be defined only in accordance with the following claims and their equivalents.

In addition, it should be understood that the figures appended hereto, which highlight the functionality and advantages of the present technology, are presented for example purposes only. The architecture of the present technology is sufficiently flexible and configurable, such that it may be utilized (and navigated) in ways other than that shown in the accompanying figures.

Further, the purpose of the foregoing Abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The Abstract is not intended to be limiting as to the scope of the present technology in any way. It is also to be understood that the steps and processes recited in the claims need not be performed in the order presented.

What is claimed is:

1. A computerized method of controlling a virtual environment of a user, comprising:
providing, over a communications network, a plurality of virtual environments in which a user is able to interact with other users using electronic messaging;
transmitting, from an authentication server, information about the plurality of virtual environments to a first computing device associated with an agent in response to user request for access to a restricted electronic messaging format associated with one of the virtual worlds;
receiving, at the authentication server, an indication of authorization from the first computing device, wherein the indication of authorization includes a separate indication of authorization associated with each of the plurality of virtual environments.

2. The method of claim 1 wherein the virtual environments are associated with one or more publications, the method further comprising receiving, at the authentication server, a second indication of authorization associated with subscriptions to the one or more publications.

3. The method of claim 1 wherein the information includes at least one of information for an account associated with the user or information for an account associated with the agent.

4. The method of claim 1, further comprising a message checker that prevents electronic messaging that comprises certain combination of predetermined or unpredetermined messages in interactions between users.

5. The method of claim 4, wherein the message checker excludes contents that include personal identification of the user and contents deemed inappropriate for the user based on the indication of authorization.

6. The method of claim 1, wherein the information is transmitted to the agent by email.

7. The method of claim 1, wherein the user is a child and the agent is a parent of the child.

8. A computer program product, tangibly embodied in a machine-readable storage device, the computer program product including instructions being operable to cause a data processing apparatus to:
provide, over a communications network, a plurality of virtual environments in which a user is able to interact with other users using electronic messaging;
transmit, from an authentication server, information about the plurality of virtual environments to a first computing device associated with an agent in response to the user request for access to a restricted electronic messaging format associated with one of the virtual worlds;
receive, at the authentication server, an indication of authorization from the first computing device, wherein the indication of authorization includes a separate indication of authorization associated with each of the plurality of virtual environments.

9. A computerized method comprising:
providing, by an authentication server, a dashboard-style interface having a first worksheet, a second worksheet, a third worksheet, and a fourth worksheet to display on a computing device associated with an agent;
selecting, by the authentication server, a first set of information to be displayed on the dashboard based on criteria preselected by the agent, a second set of information provided by a user who is associated with the agent, a third set of information associated with electronic publication subscriptions selected by the user, and a fourth set of information associated with changes made by the user to the one or more virtual world user accounts;
transmitting, from the authentication server, the first set of information to be displayed on the first worksheet, the second set of information to be displayed on the second worksheet, the third set of information to be displayed on a third worksheet, and the fourth set of information to be displayed on a fourth worksheet.

10. The method of claim 9 further comprising transmitting an email to an email address associated with the agent when updates are made to the first set of information, the second set of information, the third set of information, or the fourth set of information.

11. The method of claim 9 further comprising transmitting a SMS formatted message to the computing device associated with the agent when updates are made to the first set of information, the second set of information, the third set of information, or the fourth set of information.

12. The method of claim 11 further comprising:
requesting, by the authentication server, information associated with the computed device so that the computing device will be registered with the authentication server;
receiving, at the authentication server, information associated with the computing device such that the SMS formatted message can be transmitted to a registered computing device.

13. A computer program product, tangibly embodied in a machine-readable storage device, the computer program product including instructions being operable to cause a data processing apparatus to:
provide, by an authentication server, a dashboard-style interface having a first worksheet, a second worksheet, a third worksheet, and a fourth worksheet to display on a computing device associated with an agent;
select, by the authentication server, a first set of information to be displayed on the dashboard based on criteria preselected by the agent, a second set of information provided by a user who is associated with the agent, a third set of information associated with electronic publication subscriptions selected by the user, and a fourth set of information associated with changes made by the user to the one or more virtual world user accounts;
transmit, from the authentication server, the first set of information to be displayed on the first worksheet, the second set of information to be displayed on the second worksheet, the third set of information to be displayed on a third worksheet, and the fourth set of information to be displayed on a fourth worksheet.
